(19) United States
(12) Patent Application Publication
(10) Pub. No.: US 2025/0047331 A1
(43) Pub. Date: Feb. 6, 2025

(54) METHOD AND APPARATUS FOR CSI PREDICTION AT THE USER TERMINAL AND PERFORMANCE MONITORING AT THE NETWORK IN WIRELESS COMMUNICATION SYSTEM

(71) Applicant: Samsung Electronics Co., Ltd., Suwon-si (KR)

(72) Inventors: Ameha Tsegaye ABEBE, Suwon-si (KR); Kyoungmin PARK, Suwon-si (KR); Taehan BAE, Suwon-si (KR); Seongmok LIM, Suwon-si (KR); Youngrok JANG, Suwon-si (KR); Hyoungju JI, Suwon-si (KR)

(21) Appl. No.: 18/794,633

(22) Filed: Aug. 5, 2024

(30) Foreign Application Priority Data
Aug. 3, 2023 (KR) 10-2023-0101773
Apr. 29, 2024 (KR) 10-2024-0057130

(51) Int. Cl. H04B 7/0417; H04B 7/06; H04W 24/10

(52) U.S. Cl. CPC H04B 7/0417; H04B 7/0626; H04B 7/0639; H04W 24/10

(57) ABSTRACT

The disclosure relates to a 5G or 6G communication system for supporting a higher data transmission rate. A method performed by a user equipment (UE) in a communication system is provided. The method includes receiving, from a base station via higher layer signaling, one or more configurations, identifying a first CSI report for prediction and a second CSI report for monitoring based on the one or more configurations, and transmitting, to the base station, the first CSI report for prediction and the second CSI report for monitoring.

### CROSS-REFERENCE TO RELATED APPLICATION(S)

This application is based on and claims priority under 35 U.S.C. § 119 (a) of a Korean patent application number 10-2023-0101773, filed on Aug. 3, 2023, in the Korean Intellectual Property Office, and of a Korean patent application number 10-2024-0057130, filed on Apr. 29, 2024, in the Korean Intellectual Property Office, the disclosure of each of which is incorporated by reference herein in its entirety.

### BACKGROUND

### 1. Field

The disclosure relates to the field of 5th generation (5G) and beyond 5G communication networks. More particularly, the disclosure relates to mechanisms to monitor at the network (including base station) the performance of channel state information (CSI) prediction at the user terminal, and introduces configuration from the base station to the user terminal for measurement and reporting of CSI for monitoring purpose.

### 2. Description of Related Art

To meet the demand for wireless data traffic having increased since deployment of 4th generation (4G) communication systems, efforts have been made to develop an improved 5G or pre-5G communication system. Therefore, the 5G or pre-5G communication system is also called a ‘Beyond 4G Network’ or a ‘Post long-term evolution (LTE) System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like. In the 5G system, hybrid frequency shift keying (FSK) and quadrature amplitude modulation (QAM) modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “Security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including a smart home, a smart building, a smart city, a smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies, such as a sensor network, machine type communication (MTC), and machine-to-machine (M2M) communication may be implemented by beamforming, MIMO, and array antennas. Application of a cloud radio access network (RAN) as the above-described big data processing technology may also be considered to be as an example of convergence between the 5G technology and the IoT technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and apparatus for monitoring mechanism at the base station to monitor the performance of channel state information (CSI) prediction at the user terminal.

Another aspect of the disclosure is to provide methods and systems for the user terminal to report its capability by including information pertaining to CSI measurement and reporting for monitoring purposes.

Another aspect of the disclosure is to provide methods and systems for the base station to receive the related capability reports from the user terminal and to configure the terminal with CSI measurement and reporting configurations for monitoring purpose.

Another aspect of the disclosure is to provide methods and systems for the user terminal, up on the reception of configuration information from the bases station, to measure and report CSI for monitoring purposes.

Another aspect of the disclosure is to provide methods and systems for managing the CSI processing units (CPUs) of a user terminal for the measurement and reporting for CSI for monitoring purposes.

Another aspect of the disclosure is to provide methods and systems for the user terminal to compress the CSI measured from multiple measurement resources and report to accordingly.

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes transmitting, to a terminal, configuration information for measurement and reporting of CSI to monitor the performance of CSI prediction.

In accordance with another aspect of the disclosure, a method performed by a user terminal in a wireless communication system is provided. The method includes receiving, from a base station, configuration information pertaining to measurement and reporting of CSI to monitor the performance of CSI prediction.

In accordance with another aspect of the disclosure, a method performed by a user terminal in a wireless communication system is provided. The method includes transmitting, by a terminal, capability information pertaining to measurement and reporting of CSI to monitor the performance of CSI prediction.

In accordance with another aspect of the disclosure, a method performed by a base station in a wireless communication system is provided. The method includes transmitting, to a terminal, information to activate/deactivate/switch/monitor artificial intelligence markup language (AIML) functionalities, models.

In accordance with another aspect of the disclosure, a method performed by a user terminal in a wireless communication system is provided. The method includes receiving, from a base station, information to activate/deactivate/switch/monitor AIML functionalities, models.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIGS. 2A and 2B illustrate wireless transmit and receive paths according to various embodiments of the disclosure;

FIGS. 3A and 3B illustrate a user equipment (UE) and gNodeB (gNB), respectively, according to various embodiments of the disclosure;

FIG. 4 illustrates a cross-polarized multiple-input multiple-output (MIMO) antenna system according to an embodiment of the disclosure;

FIG. 5 illustrates a layout for channel state information reference signal (CSI-RS) resource mapping in an orthogonal frequency division multiple access (OFDM) time-frequency grid according to an embodiment of the disclosure;

FIG. 6 illustrates a precoder construction in Type II CSI according to an embodiment of the disclosure;

FIG. 7 illustrates single-sided and two-sided models according to an embodiment of the disclosure;

FIG. 8 illustrates two-sided model-based artificial intelligence/machine learning (AI/ML) CSI feedback according to an embodiment of the disclosure;

FIG. 9 illustrates measurement and reporting framework for monitoring predicted CSI according to an embodiment of the disclosure;

FIG. 10 illustrates a flowchart for measurement and reporting framework for monitoring predicted CSI according to an embodiment of the disclosure;

FIG. 11 illustrates for two-linked CSI reporting configuration for predicted CSI and CSI for monitoring according to an embodiment of the disclosure;

FIG. 12 illustrates measurement resources configuration for monitoring according to an embodiment of the disclosure;

FIGS. 13A, 13B, and 13C illustrate various CSI report configurations for monitoring according to an embodiment of the disclosure;

FIG. 14A illustrates a case for CSI computation unit (CPU) occupancy rule according to an embodiment of the disclosure;

FIG. 14B illustrates a case for CSI computation unit (CPU) occupancy rule according to an embodiment of the disclosure;

FIG. 14C illustrates a case for CSI computation unit (CPU) occupancy rule according to an embodiment of the disclosure;

FIG. 15 illustrates dropping rule for configured CSI-RS resource for monitoring according to an embodiment of the disclosure;

FIG. 16 illustrates two-parts CSI for predicted CSI and CSI for monitoring according to an embodiment of the disclosure;

FIG. 17 illustrates framework for Doppler-domain compression according to an embodiment of the disclosure;

FIG. 18 illustrates an auto-encoder (AE) consisting of an encoder part at the UE and a decoder at the gNB according to an embodiment of the disclosure;

FIG. 19 illustrates formats for an input of auto-encoder according to an embodiment of the disclosure;

FIG. 20 illustrates channel measurement from sounding reference signal (SRS) and channel delivery from radio unit (RU) to the distributed unit (DU) according to an embodiment of the disclosure;

FIG. 21 illustrates procedures for RU preprocessing the SRS signal according to an embodiment of the disclosure; and

FIG. 22 illustrates channel measurement from SRS by RUs including master RU according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the disclosure may be applied to deployment of 5G communication systems, 6G or even later releases which may use THz bands. To decrease propagation loss of the radio waves and increase the transmission distance, the beamforming, massive multiple-input multiple-output (MIMO), full dimensional MIMO (FD-MIMO), array antenna, an analog beam forming, large-scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

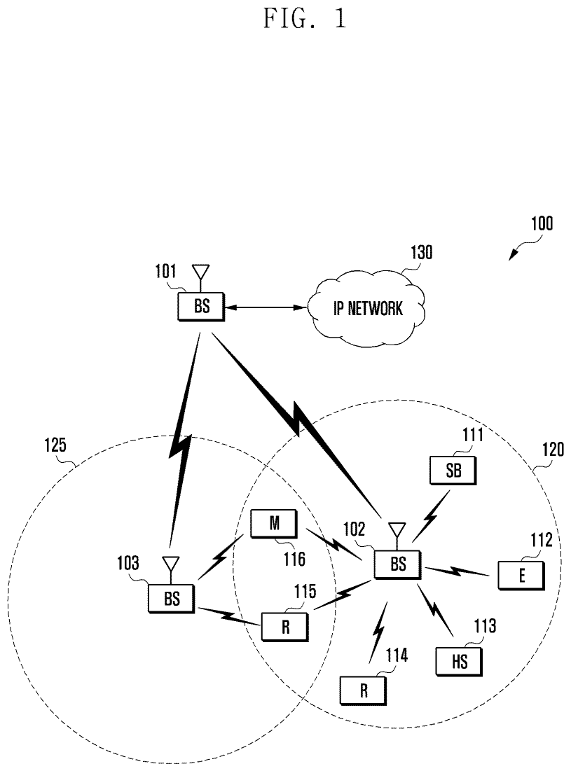

FIG. 1 illustrates a wireless network according to an embodiment of the disclosure.

Referring to FIG. 1, an embodiment of a wireless network 100 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. In addition, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance, or the like.

The gNB 102 provides wireless broadband access to the network 130 for a first plurality of user equipments (UEs) within a coverage area 120 of the gNB 102. The first plurality of UEs includes a UE 111, which may be located in a small business (SB), a UE 112, which may be located in an enterprise (E), a UE 113, which may be located in a WiFi hotspot (HS), a UE 114, which may be located in a first residence (R), a UE 115, which may be located in a second residence (R), and a UE 116, which may be a mobile device (M) like a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116. In some embodiments of the disclosure, one or more of the gNBs 101-103 may communicate with each other and with the UEs 111-116 using 5G, long-term evolution (LTE), LTE-advanced (LTE-A), WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described below, one or more of BS 101, BS 102 and BS 103 include 2-dimensional (2D) antenna arrays as described in embodiments of the disclosure. In some embodiments of the disclosure, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. In addition, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

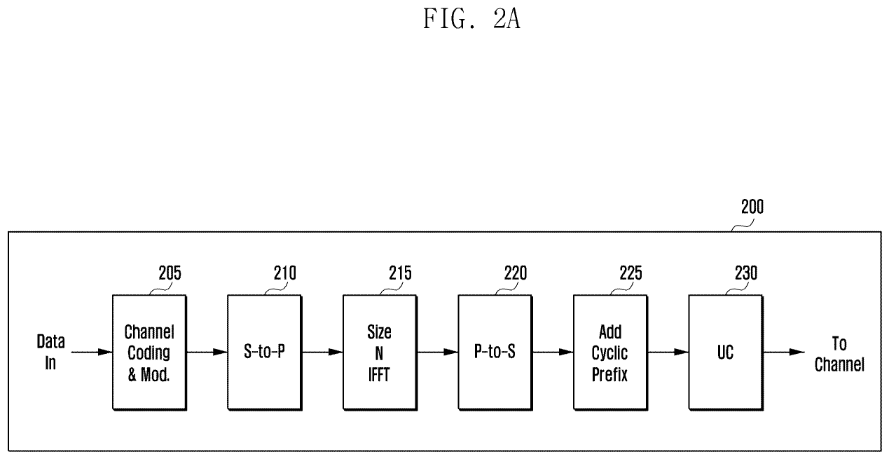

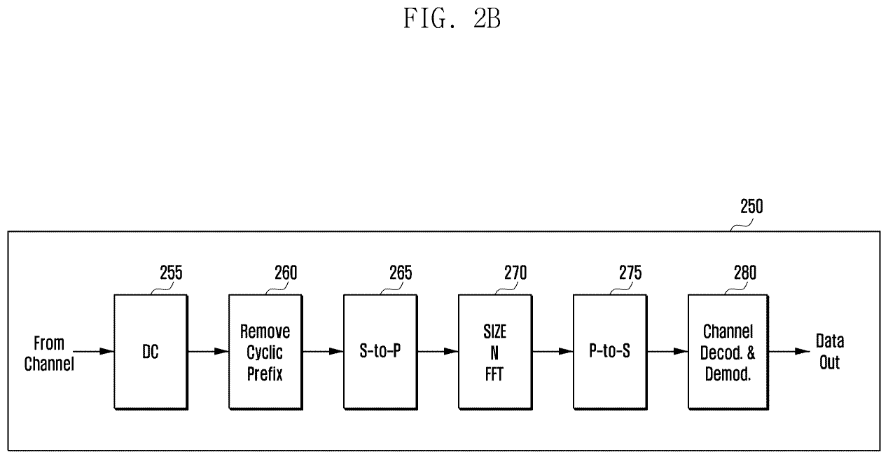

FIGS. 2A and 2B illustrate wireless transmit and receive paths according to various embodiments of the disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments of the disclosure, the receive path 250 is configured to support the codebook design and structure for systems having 2D antenna arrays as described in embodiments of the disclosure.

The transmit path 200 includes a channel coding and modulation block 205, a serial-to-parallel (S-to-P) block 210, a size N inverse fast Fourier transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N fast Fourier transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to a radio frequency (RF) frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as discrete Fourier transform (DFT) and inverse discrete Fourier transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. In addition, FIGS. 2A and 2B are meant to illustrate examples of the types of transmit and receive paths that can be used in a wireless network. Any other suitable architectures can be used to support wireless communications in a wireless network.

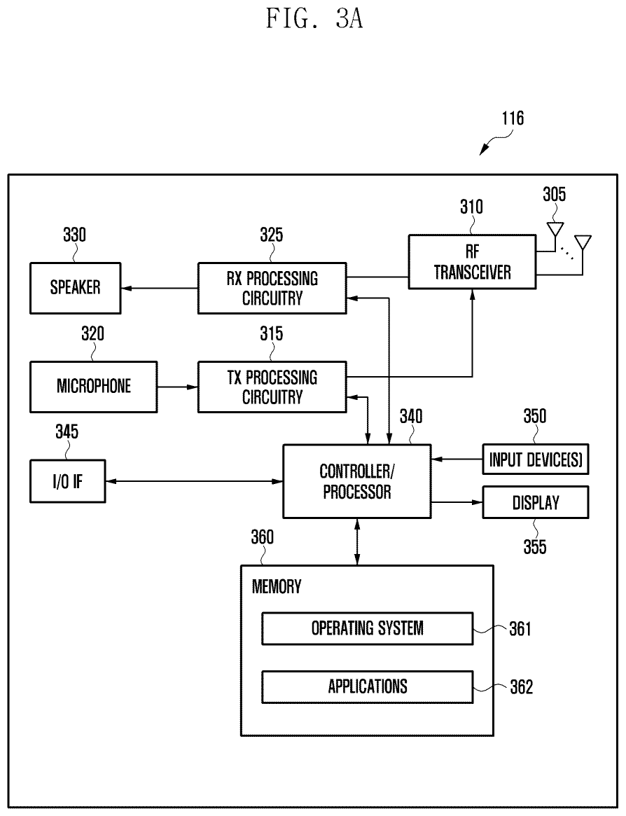

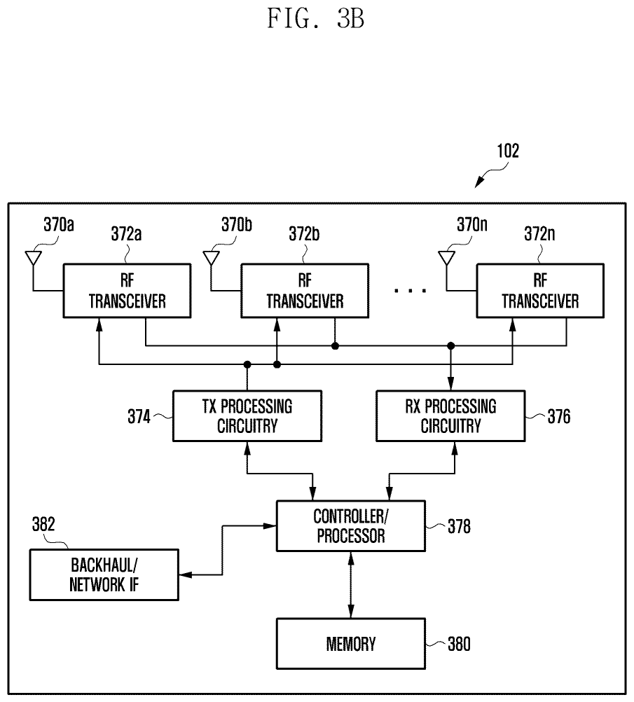

FIG. 3A illustrates a UE 116 according to an embodiment of the disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments of the disclosure, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the disclosure. The main processor 340 can move data into or out of the memory 360 as required by an executing process. In some embodiments of the disclosure, the main processor 340 is configured to execute the applications 362 based on the OS program 361 or in response to signals received from gNBs or an operator. The main processor 340 is also coupled to the I/O interface 345, which provides the UE 116 with the ability to connect to other devices, such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include random access memory (RAM), and another part of the memory 360 can include flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). In addition, while FIG. 3A illustrates the UE 116 configured as a mobile telephone or smartphone, UEs can be configured to operate as other types of mobile or stationary devices.

FIG. 3B illustrates a gNB 102 according to an embodiment of the disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

Referring to FIG. 3B, the gNB 102 includes multiple antennas 370a-370n, multiple RF transceivers 372a-372n, transmit (TX) processing circuitry 374, and receive (RX) processing circuitry 376. In certain embodiments of the disclosure, one or more of the multiple antennas 370a-370n include 2D antenna arrays. The gNB 102 also includes a controller/processor 378, memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments of the disclosure, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the disclosure. In some embodiments of the disclosure, the controller/processor 378 supports communications between entities, such as web real time communication (RTC). The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an ethernet or RF transceiver.

The memory 380 is coupled to the controller/processor 378. Part of the memory 380 can include a RAM, and another part of the memory 380 can include flash memory or other ROM. In certain embodiments of the disclosure, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of frequency division duplex (FDD) cells and time division duplex (TDD) cells.

Although FIG. 3B illustrates one example of a gNB 102, various changes may be made to FIG. 3B. For example, the gNB 102 can include any number of each component shown in FIG. 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Multiple input multiple output (MIMO) system wherein a BS and/or a UE is equipped with multiple antennas has been widely employed in wireless systems for its advantages in terms of spatial multiplexing, diversity gain and array gain.

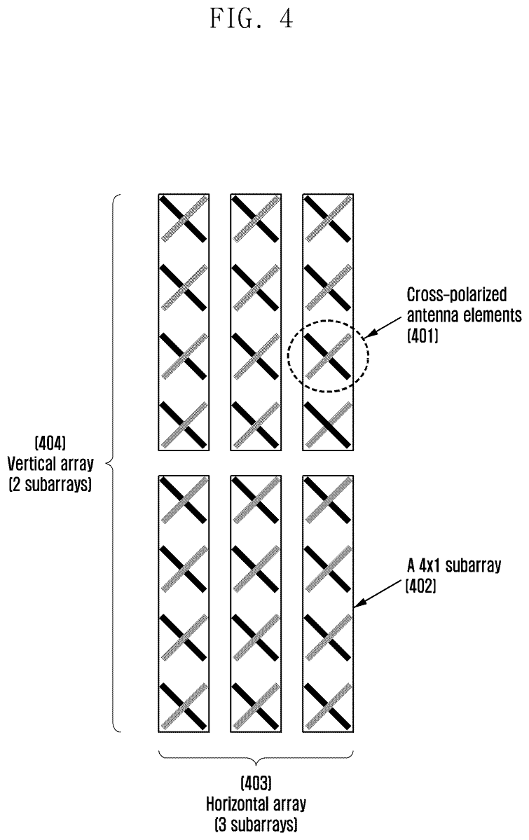

FIG. 4 illustrates a MIMO antenna configuration with 24 antenna elements according to an embodiment of the disclosure.

Referring to FIG. 4, 4 cross-polarized 401 antenna elements form a 4×1 subarray. 12 subarrays form a 2V3H MIMO antennas configuration consisting 2 and 3 subarrays in vertical and horizontal dimensions, respectively. Although FIG. 4 illustrates one example of MIMO antenna configuration, the disclosure can be applied to various such configurations.

In MIMO systems, the channel state information (CSI) is required at the base station (BS) so that a signal from the BS is received at the UE with maximum possible received power and minimum possible interference. The acquisition of CSI at the BS can be via a measurement at the BS from an UL reference signal or via a measurement and feedback by the UE from a DL reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

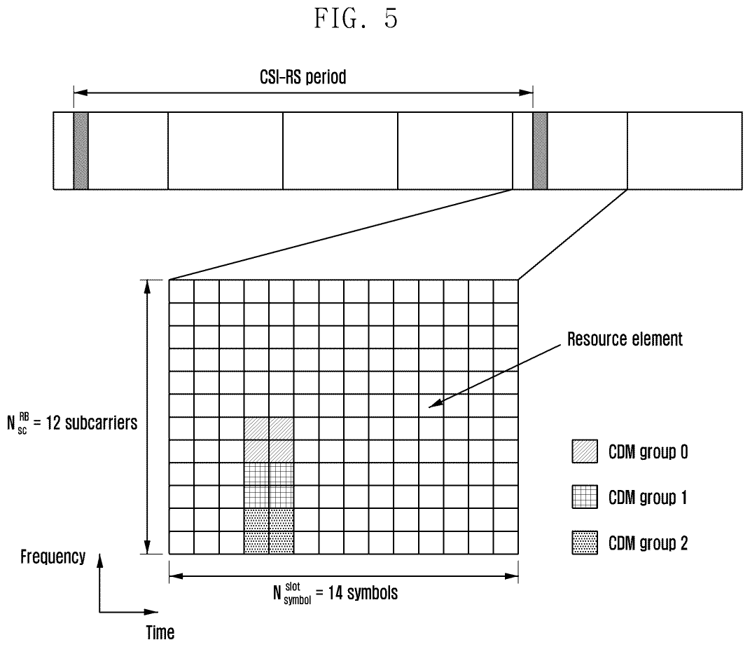

FIG. 5 illustrates a layout for channel state information reference signal (CSI-RS) resource mapping in an orthogonal frequency division multiple access (OFDM) time-frequency grid according to an embodiment of the disclosure.

Referring to FIG. 5, in some embodiments of the disclosure, a UE may receive a configuration signaling from a BS for a CSI-RS that can be used for channel measurement. An example of such configuration is illustrated in FIG. 5. In the figure, 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G NR standards, three time-domain CSI-RS resources configurations, namely: periodic, semi-persistent and aperiodic are possible. In the figure, an illustrative example of periodic configuration is given with a period of 4 slots.

Moreover a UE can be configured to measure a CSI feedback with a CSI report configuration. A CSI report configuration can be periodic, semi-persistent or aperiodic manner.

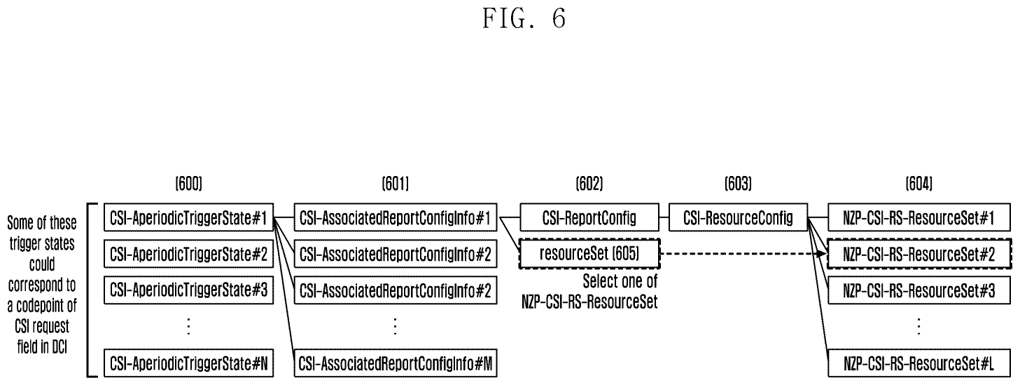

FIG. 6 depicts a CSI report configuration and CSI measurement configurations that is supported in 5G NR system according to an embodiment of the disclosure.

Referring to FIG. 6, a CSI report configuration 602 can be linked to a CSI resource configuration 603. The CSI resource configuration 603 may contain one or more CSI resource sets 604 for channel measurement (CMR) or inference measurement (IMR).

In the case of periodic (P) and semi-persistent (SP) CSI report setting, the CSI resource configuration contains a single CSI resource set. In case of aperiodic (AP) CSI report, a UE can be configured with multiple CSI report triggering states 600. A CSI report triggering state may contain one or more CSI associated report configuration information 601. A downlink control information (DCI) may include CSI request which indicates one of the configured triggering states. Moreover, the DCI with CSI request may also contain a resource set selection field 605 to select one of the resources sets 604.

Moreover, a CSI report can be configured with one of the CSI reporting quantities. This may include CSI resource indicator (CRI), the rank indicator (RI), precoding matrix indicator (PMI), channel quality indicator (CQI), layer indicator (LI), signal to interference and noise ratio (SINR), reference signal received power (RSRP). In 5G NR, various CSI reporting quantiles are adopted. More particularly, a radio resource control (RRC) parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’ or ‘ssb-Index-SINR-Index’.

The CSI reporting can be used for transmission beam management (BM), specifically, in higher frequency bands, e.g., in frequency range 2 (FR2). In this case, the gNB may configure the UE to report one of the following quantities including, ‘cri-RSRP’, ‘cri-SINR’, ‘ssb-Index-RSRP’, ‘ssb-Index-SINR’, ‘cri-RSRP-Index’, ‘ssb-Index-RSRP-Index’, ‘cri-SINR-Index’ or ‘ssb-Index-SINR-Index’.

For a yet another purpose, the CSI report can be used for the downlink transmission CSI including ‘cri-RI-PMI-CQI’, ‘cri-RI-i1’, ‘cri-RI-i1-CQI’, ‘cri-RI-CQI’.

Recently, data-driven algorithms, also known as artificial-intelligence or machine-learning (AI/ML), have gained considerable attentions. Main application areas include addressing non-linear optimization issues that cannot be directly addressed by convention solutions. Use cases that have recently been highlighted include CSI compression, CSI prediction, beam prediction, positioning, channel estimation and interpolation, multi-user (MU)-MIMO scheduling, or the like.

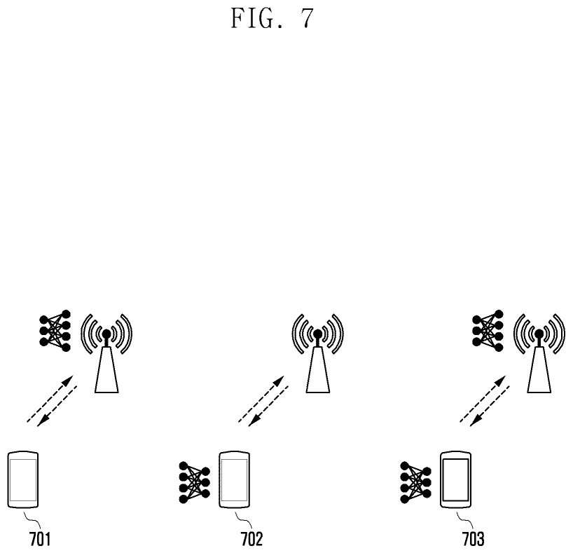

FIG. 7 illustrates single-sided and two-sided models according to an embodiment of the disclosure.

In this disclosure, any data-driven algorithm and its parts are referred as AI/ML model. Referring to FIG. 7, such AI/ML model can be located at a UE 701, network 702 or at both UE and network 703. An AI/ML model may require to be trained with a training dataset before it is used for inference (to produce a set of prediction output from set of inputs). When the AI/ML model inference is performed in one node, i.e., UE or network node, such model is referred as single-sided model or, in particular, UE-sided model or network-sided model. When the inference is jointly made at two nodes, i.e., the first part of the inference at UE and the second part at the network, the AI/ML model is said to be two-sided model.

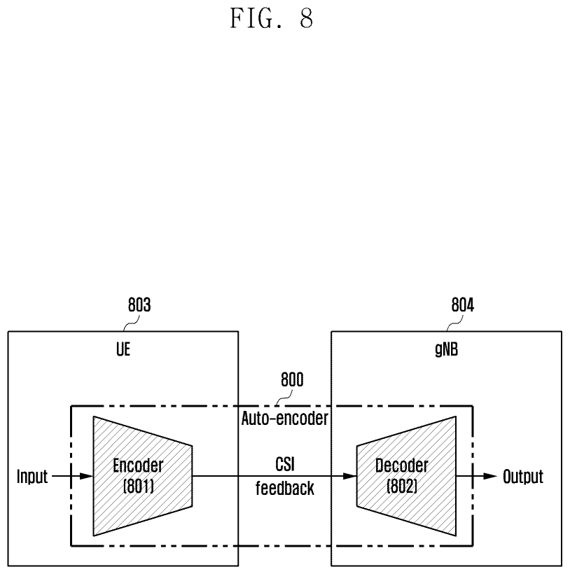

FIG. 8 illustrates two-sided model-based artificial intelligence/machine learning (AI/ML) CSI feedback according to an embodiment of the disclosure.

Referring to FIG. 8, one use case of artificial intelligence (AI) is AI/ML based CSI feedback. In particular, an auto-encoder (AE) 800, which is a two-sided model as depicted in FIG. 8, consisting of an encoder part 801 at the UE 803 which generates the CSI feedback and a decoder 802 at the gNB 804 which reconstructs the CSI feedback. The main aim of an AE-based CSI feedback is to find the best representation of a channel state information in terms of feedback overhead. In another words, AE compresses the CSI to reduce the CSI feedback overhead.

In scenarios wherein at least one of the transmitter (base station), the receiver (UE) or even the surrounding environment are mobile, the reported channel state information may stale before it is applied for the downlink data transmission, which is widely known as channel (CSI) aging. In this case, the UE may have to measure and report the CSI more frequently. However, frequent feedback implies higher measurement and reporting overhead which thus degrades system performance. Moreover, due to the CSI processing time to derive the reported CSI, in some cases, merely allowing the UE to report CSI frequently does not address the channel aging issue. In another words, no matter how frequently the UE reports CSI, the reported CSI could be aged (staled) degrading performance.

In the aforementioned scenarios and others, it may be beneficial if either the terminal or the base station predict CSI. In particular, the terminal may first predict and then report the CSI for future application times (downlink data transmission). Upon the reception of the predicted CSI, the base station then applies to the transmission of downlink data at the appropriate time. Such CSI prediction can be carried out based on AI/ML models.

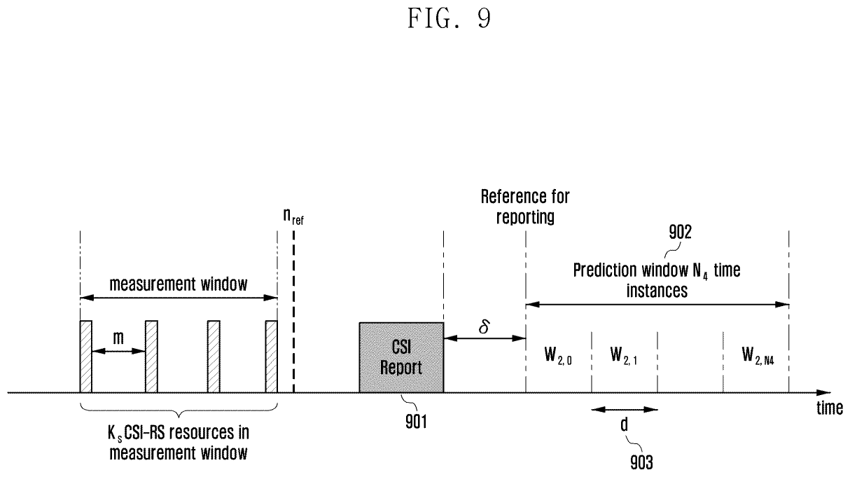

FIG. 9 illustrates a configuration wherein a UE predicts CSI by measuring Ks CSI-RS resources in a measurement window according to an embodiment of the disclosure.

Referring to FIG. 9, the predicted CSI reported by utilizing uplink resource 901 can be applied to N4 prediction instances in a prediction window 902. Each prediction instance in the prediction window which spans d slots 903 is associated to precoder information (precoding vectors) reported by the UE. Thus, the base station can utilize this precoding information to precoder the downlink transmission of physical downlink shared channel (PDSCH) in the respective application time.

However, the performance of such CSI prediction could be affected by various aspects. As an example, the CSI prediction method including the AI/ML model applied by the terminal might be applicable only to certain set of applicable scenarios and configurations. One example of such applicable scenarios is UE's speed. In particular, the AI/ML models are trained by a dataset collected from a certain set of scenarios and configurations. As an example, the AI/ML model for CSI prediction could be trained based on a training dataset associated with certain UE speed or certain range of UE speeds. In this case, if the same model is applied to predict a CSI for a UE with a different speed outside of the range of UE speeds considered for training dataset generation, the CSI prediction performance degrades. Additionally, if the AI/ML model is trained based on a dataset from a large range of UE speeds, then the performance may degrade as compared to CSI prediction based on AI/ML models trained with dataset from narrower range UE speeds. Thus, it may be beneficial for the UE to keep multiple AI/ML models each applicable to a narrower range of scenarios, e.g., UE speeds. Then, the UE may switch through these AI/ML models based on the current situation. Another action that can be carried out is to fallback to a non-prediction mode. In order to take such actions properly, however, a mechanism for active monitoring the environment and the performance of AI/ML models.

TABLE 1
Prediction - UE velocity generalization | % SGCS gains

| | 10 | 20 | 30 | 40 | 60 | 120 |
|---|---|---|---|---|---|---|
| Train↓/Test→ | kmph | kmph | kmph | kmph | kmph | kmph |
| 10 kmph | 8.8% | 8.0% | 1.5% | 11.4% | 7.4% | −2.1% |
| 20 kmph | −11.6% | 14.3% | 5.0% | 10.6% | 16.7% | −1.1% |
| 30 kmph | −27.2% | 1.6% | 11.9% | 15.9% | 25.2% | 0.3% |
| 40 kmph | −36.1% | −14.1% | 1.4% | 21.3% | 24.8% | 0.9% |
| 60 kmph | −51.2% | −29.2% | −19.5% | −5.6% | 31.6% | 8.9% |
| 120 kmph | −58.3% | −44.2% | −39.9% | −29.2% | −3.4% | 25.3% |

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the below various mechanisms for monitoring CSI prediction at the terminal are presented.

In the below detailed description of the disclosure, the terms “AI/ML model”, “model” “AI model” are used interchangeably to refer to a data-driven algorithm that takes a certain set of inputs and produces a certain set of outputs. An AI/ML model may require to be trained with a training dataset before it is used for inference (to produce a set of prediction output from set of inputs).

An AI/ML model can be neural network (NN)-based which includes a large number of interconnected neurons. The neurons can be described by parameters which may consist of weights and biases. The interconnection between neural networks may have structure. A typical form of structure is assortments of neurons into multiple layers. If the number of layers in AI/ML model is relatively large, the model can be referred as deep neural network (DNN). Then, the layers could be interconnected with dense or sparse connections.

An AI/ML model can take various backbone structures, e.g., dense neural networks (DNN) convolutional neural network (CNN), long-short term memory (LSTM), transformer (TF), or the like.

An AI/ML model can be scenario-specific or configuration-specific, i.e., it provides the desired performance only in a set of scenarios or set of configurations. These models are typically trained by a dataset collected from a certain set of scenarios and configurations. For example, an AI/ML CSI compression model may perform as desired only when it is applied to a set of CSI ports (antenna ports) configuration or CSI payload size configurations. In another case, an AI/ML-based CSI compression model may work only under certain set of scenarios, e.g., UE speed.

In some embodiments of the disclosure, the UE or network may have to keep multiple scenario/configurations specific AI/ML models for different sets of scenarios or configurations. Thus, when a certain set of configurations is applied or a certain scenarios is detected, the UE or network may select the appropriate model, i.e., model selection.

In some embodiments of the disclosure, the UE or network may have to activate the appropriate AI/ML model for inference. This activation process may require the UE or network to load the model to the processing unit, e.g., central processing unit (CPU), graphics processing unit (GPU), neural processing unit (NPU), or the like.

In some embodiments of the disclosure, the UE or network may have to deactivate an AI/ML model. This deactivation process may include unloading the model from the processing unit (freeing up the processing unit), e.g., central processing unit (CPU), graphics processing unit (GPU), and neural processing unit (NPU).

In some embodiments of the disclosure, the UE or network may have to switch through AI/ML models depending on the scenarios and configurations. The switching process may include deactivation, selection and activation of AI/ML models.

In some embodiments of the disclosure, the UE or network may have to update AI/ML models based dataset for a set of scenarios and configurations. The model update process may include at least updating the model parameters based on training dataset.

In some embodiments of the disclosure, the UE or network may have to collect training dataset for a given scenarios or configurations. The training data collected can then be applied to train a new model or update an existing one.

In some embodiments of the disclosure, the UE or network may have to monitor the performance of AI/ML model. The model monitoring process may include comparison of the output from AI/ML model to the ground truth. In some cases, one node makes measurement of the ground truth and one node makes AI/ML model inference. In such cases, it may be necessary to exchange monitoring dataset, e.g., ground truth, AI/ML model inference output, from one node to the other.

In some embodiments of the disclosure, one node, e.g., network node, UE, may train a model and transfer to the other node. The model can be compiled for execution before or after the model transfer. This may be beneficial as it allows to train the model in the environment it is going to be used (for inference).

The process of managing the different aspects mentioned above, including: data collection, model training, model selection, model activation, model inference, model deactivation, model switching, model updating, model monitoring, etc., can be referred as model life cycle management (LCM).

In some embodiments of the disclosure, a node can give assistance or control the LCM of a model in another node. As a typical example, the network may assist/control a model in the UE side for UE-side or UE part of two-sided model.).

In some consideration, the network may provide the LCM assistance to the UE by being specific to a particular model. Thus, the network may be required to identify the model in UE side unambiguously. For this purpose a model ID can be used. This type of model LCM assistance can be termed as model-ID based LCM.

In some embodiments of the disclosure, the performance of AI/ML-based CSI prediction is performed at the base station. One consideration to carryout performance monitoring is for the base station to compare the predicted CSI and the ground truth CSI. In this case the base station may get access to the ground truth CSI through the UE's report or through some form of uplink measurement.

In some embodiments of the disclosure, the performance of AI/ML-based CSI prediction is performed at the UE. One consideration to carryout performance monitoring is for the UE is to compare the predicted CSI and the ground truth CSI. In this case the UE may get access to the ground truth CSI through indirect or a dedicated measurement.

### CSI Report Configuration

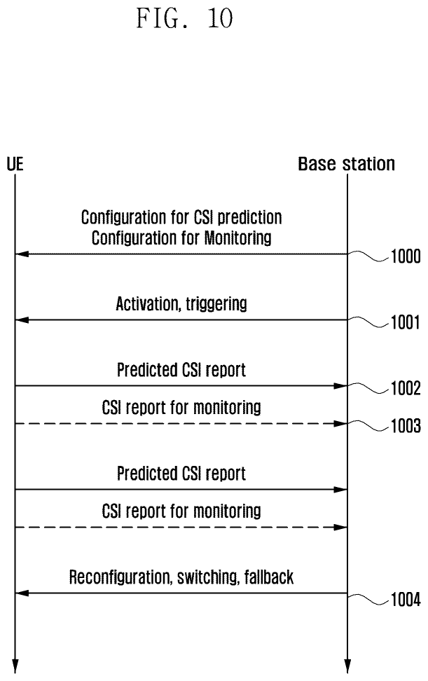

FIG. 10 depicts a flowchart for performance monitoring of CSI prediction at the base station according to an embodiment of the disclosure.

More particularly, the base station configures measurement and reporting method for CSI prediction and the corresponding report for monitoring in operation 1000. In the case of semi-persistent and aperiodic CSI reporting, the configuration in operation 1000 could be activated or triggered by additional message from the bases station in operation 1001. Such additional message could be via medium access control-control element (MAC-CE) or downlink control indication (DCI). Upon the reception of such configuration and optionally additional activating or triggering messages, the UE may report the corresponding predicted CSI in operation 1002 and ground truth CSI for monitoring purpose in operation 1003. The monitoring process may be followed by reconfiguration, switching or fallback for the CSI measurement and reporting in operation 1004.

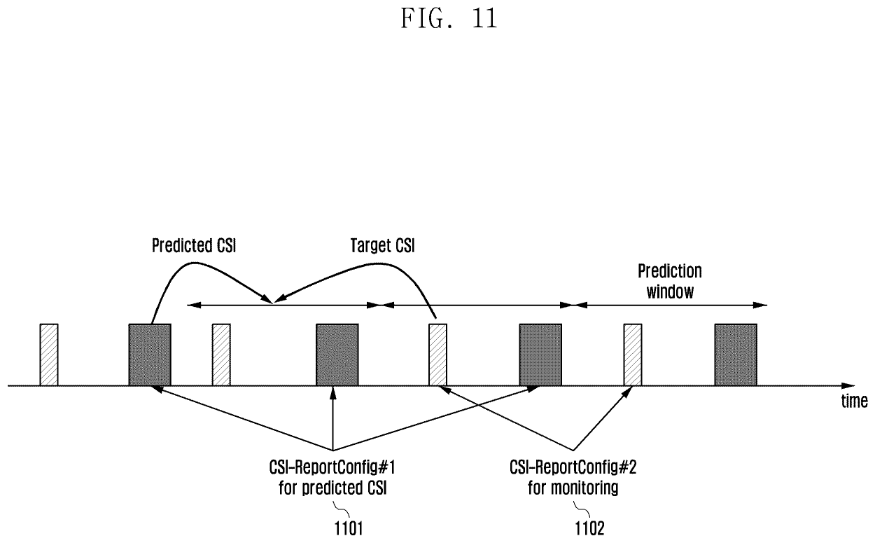

As an embodiment of the disclosure, a timeline for predicted CSI and a corresponding CSI report for monitoring purpose is depicted in FIG. 11.

FIG. 11 depicts two CSI report configurations, i.e., CSI-ReportConfig #1 1101 and CSI-ReportConfig #2 1102 for predicted CSI and CSI report for monitoring, respectively, according to an embodiment of the disclosure.

Referring to FIG. 11, it is shown that two CSI reports are associated to the same prediction window. The CSI for monitoring purpose is measured in one or multitude of the associated application time instances of a prediction window for the corresponding predicted CSI.

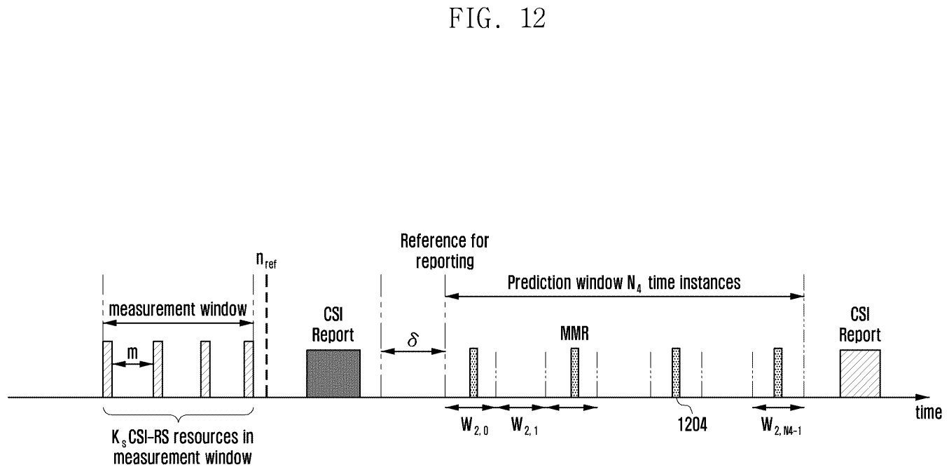

FIG. 12 illustrates a method for the base station to configure CSI measurement resources for monitoring purpose according to an embodiment of the disclosure.

Referring to FIG. 12, the CSI measurement resources for monitoring purpose could be named as monitoring measurement resources (MMRs). An MMR 1204 could be a non-zero power CSI-RS resources (NZP-CSI-RS) resources or synchronization signal block (SSB) resources. The CSI monitoring measurement resource is measured within the prediction window.

As one aspect of the disclosure, a restriction could be introduced for the CSI-RS resources for channel measurement (CMR) and the CSI-RS resources for monitoring measurement resources (MMRs). As one restriction that can be introduced in accordance to the disclosure, the UE expects the same number of CSI-RS ports for CMRs and MMRs. As a yet another restriction, a UE does not expect to be configured with different received power as indicated by higher layer parameter powerControlOffset and powerControlOffsetSS, if configured.

As a yet another aspect of the proposed disclosure, methods for the base station to configure CSI report for predicted CSI and the associated monitoring.

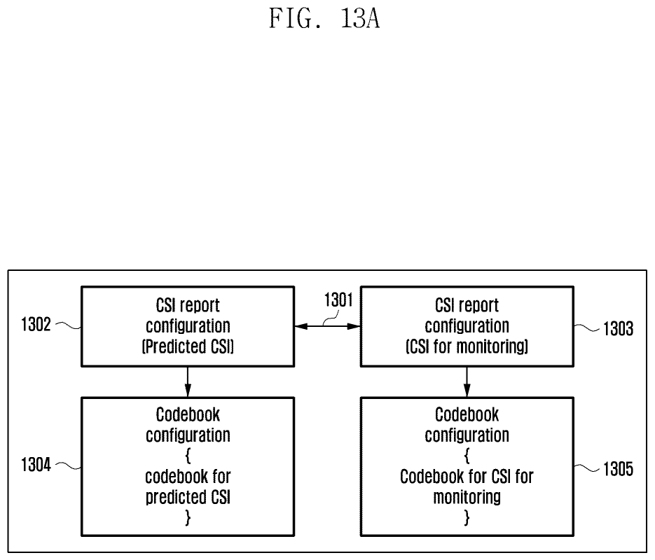

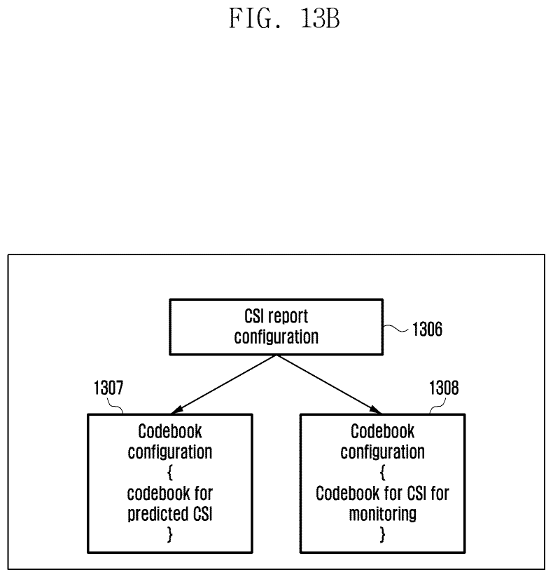

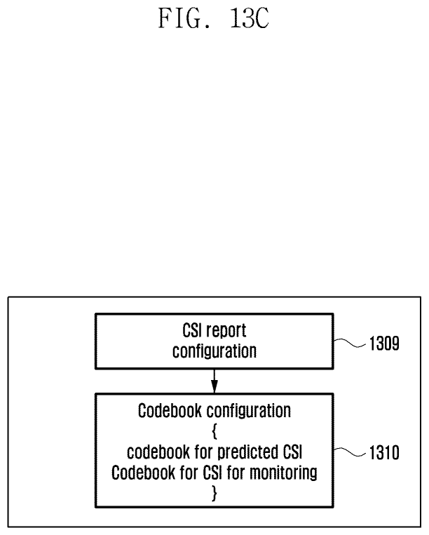

FIGS. 13A, 13B, and 13C illustrate various CSI report configurations for monitoring according to an embodiment of the disclosure.

Referring to FIG. 13A, it illustrates one aspect, a method for the base station to configure CSI report for monitoring purpose, Method I.1. In this method, the base station configures the UE with CSI report configuration via the higher layer parameter CSI-ReportConfig for predicted CSI 1302 and for monitoring purpose 1303, separately. The two CSI report configurations may configure channel measurement resources and interference measurement resources. The two CSI report configurations may also contain codebook configurations 1304, 1305. These two CSI report configurations could also be linked 1301 by gNB's indication in RRC, MAC-CE or DCI. As an example, the RRC information element (IE) CSI-ReportConfig for CSI monitoring may indicate the CSI-ReportConfigid of the corresponding CSI report configuration of predicted CSI to be monitored. This linkage via CSI-ReportConfigid can also be carried out by MAC-CE or DCI that activates or triggers the CSI report for monitoring purpose. In particular, when the bases station activate or triggers a semi-static or aperiodic CSI report for monitoring, the base station may indicate the CSI-ReportConfigid of the corresponding CSI report for monitoring. Additionally, the base station may provide the CSI-ReportConfigid of the corresponding predicted CSI to be monitored.

When the UE reports CSI for monitoring purpose, it is beneficial if the UE takes the same codebook assumption for the reported predicted CSI and the corresponding CSI for monitoring purpose. This allows the base station to make a straightforward comparison between the two CSI reports. As a yet another aspect of this disclosure, some restrictions can be introduced for the two linked CSI report configurations. If the two CSI report configurations are linked, the UE may expect the same codebook configuration for the two linked CSI configurations.

In some cases, the base station could also configure codebook configurations for one of the linked CSI reporting configurations, e.g., for predicted CSI report. Then, the UE may assume the same codebook configuration for reporting CSI for monitoring purpose to be the same as the codebook configuration for the predicted CSI.

In accordance with the disclosure, a yet another restriction for the two linked CSI report configurations can also be introduced. If two CSI report configurations are linked in accordance with Method I.1., some restrictions could be followed for their time domain property configured by the higher layer parameter reportConfigType for aperiodic, semi-persistent and periodic CSI. A restriction is depicted in the Table 2.

TABLE 2

Predicted CSI Test→

| Monitoring CSI ↓ | Aperiodic | Semi-persistent | Periodic |
|---|---|---|---|
| Aperiodic | Possible | Possible | Possible |
| Semi-persistent | Not possible | Possible | Possible |
| Periodic | Not possible | Not possible | Possible |

Referring to FIG. 13B, in yet another aspect, a method for the base station to configure CSI report for monitoring purpose, Method I.2. In this method, the base station configures the UE with a single CSI report configuration 1306 via a higher layer IE CSI-ReportConfig wherein the CSI report configuration would consist of codebook configuration for predicted CSI 1307 and for monitoring purpose 1308. Moreover, the CSI report configuration in Method I.2 could also consist of configuration information for the measurement resources for the predicted CSI report and corresponding report for monitoring purpose. In accordance with the disclosure, a higher layer parameter for configuration of these measurement resources is given by resourcesForChannelMeasrement and resourcesForMonitoringMeasurment for CMR and IMR, respectively.

Moreover, the CSI report configuration in accordance of Method I.2 could also consist of uplink resource for the two CSI reports. As CSI reports for the predicted CSI and for its monitoring are reported in different slots, it is necessary to configure two separate resources for these CSI reports. A higher layer parameter

In accordance with the disclosure, a higher layer configuration is provided below. As an example, when the higher layer parameter reportconfigType is set to ‘periodic’, the legacy parameter ‘reportSlotConfig’ indicates the reporting slot configuration for predicted CSI. Additionally, new higher layer parameter monitoringReportSlotConfig could also be introduced. This parameter could indicate the reporting slot and periodicity configuration for CSI report for monitoring purpose.

Similarly, when the higher layer parameter reportconfigType is set to ‘semi-persistentOnPUCCH’, the legacy parameter ‘reportSlotConfig’ and ‘pucch-CSI-ResourceList’ indicates the reporting slot configuration for predicted CSI and physical uplink control channel (PUCCH) resource for carrying the CSI report. Additionally, new higher layer parameters ‘monitoringReportSlotConfig’ and ‘monitoring-pucch-CSI-ResourceList” could also be introduced. These parameters could indicate the reporting slot, periodicity and PUCCH resources configuration for CSI report for monitoring purpose.

Similarly, when the higher layer parameter reportconfigType is set to ‘semi-persistentOnPUSCH’, the legacy parameter ‘reportSlotConfig’, ‘reportSlotOffsetList’ and ‘p0alpha’ indicate the reporting slot configuration for predicted CSI and physical uplink shared channel (PUSCH) resource for carrying the CSI report. Additionally, new higher layer parameters ‘monitoringReportSlotConfig’, ‘monitoringReportSlotOffsetList’ and ‘monitoring-p0alpha’ could also be introduced. These parameters could indicate the reporting slot, periodicity and PUSCH resources configuration for CSI report for monitoring purpose.

Additionally, when the higher layer parameter reportconfigType is set to ‘Aperiodic, the legacy parameter ‘reportSlotOffsetList’ indicates the reporting slot configuration for predicted CSI and PUSCH resource for carrying the CSI report. Additionally, new higher layer parameters ‘monitoring-reportSlotOffsetList’ could also be introduced. These parameters could indicate the reporting slot, periodicity and PUSCH resources configuration for CSI report for monitoring purpose.

TABLE 3

| | |
|---|---|
| CSI-ReportConfig ::= | SEQUENCE { |
| reportConfigId | CSI-ReportConfigId, |
| .... R | |
| reportConfigType | CHOICE { |
| periodic | SEQUENCE { |
| reportSlotConfig | CSI-ReportPeriodicityAndOffset, |
| monitoringReportSlotConfig | CSI-ReportPeriodicityAndOffset, |
| pucch-CSI-ResourceList | SEQUENCE (SIZE (1..maxNrofBWPs)) OF |
| | PUCCH-CSI-Resource }, |
| semiPersistentOnPUCCH | SEQUENCE { |
| semiPersistentOnPUSCH | SEQUENCE { |
| aperiodic | SEQUENCE { |
| reportSlotOffsetList | SEQUENCE (SIZE (1..maxNrofUL- |
| | Allocations)) OF INTEGER(0..32)}}, |
| monitoringReportSlotOffsetList | SEQUENCE (SIZE |

(1..maxNrofUL-Allocations)) OF INTEGER(0..32)}},

Referring to FIG. 13C, in a yet another aspect, a method for the base station to configure CSI report for monitoring purpose, Method I.3. In this method, the base station configures the UE with a single CSI report configuration 1309 via the higher layer parameter CSI-ReportConfig for predicted CSI and for monitoring purpose. In some cases it is beneficial if the two CSI reports follow the same reporting codebook. Moreover, in accordance to the configuration in Method I.3., the CSI report configuration could contain a single codebook configuration 1310. As an example, if the CSI-report configuration for the predicted CSI and monitoring CSI are configured with a single or the same higher layer parameter reportQuanity set to ‘cri-RI-CQI-PMI’ or ‘cri-RI-PMI-CQI-LI’, then the UE drives the CSI reports for the two CSI reports by applying the same codebook configured in ‘codebookConfig’.

### Reporting Quantity and Restrictions

The mechanism to compare the predicted CSI and the target CSI reported for monitoring purpose may vary depending on the base station's implementation, the target key performance indicator, the sensitivity of the monitoring mechanism and others. However, it is generally beneficial if the UE aligns some of the assumptions for predicted CSI and CSI for monitoring purpose.

As an embodiment of the disclosure, the reportQuantity for the CSI report for monitoring purpose could be configured separately. This is a straightforward consequence of Method I.1 as the CSI report for predicted CSI and monitoring purpose are separately configured. However, in accordance to Method I.2 and Method I.3, when the two CSI reports are configured in a single configuration, it is required to differentiate which CSI reportQuantity belongs to which report. Thus, in accordance to the disclosure, if two CSI reports one for predicted CSI and one for monitoring purpose are configured in a single CSI report configuration, according to this embodiment of the disclosure, reporting quantity for the two CSI reports are provided by two higher layer parameters, separately. As an example, the higher layer parameter reportQuantity corresponds to the CSI report for predicted CSI and the higher layer parameter report QuantityForMonitoring corresponds to the CSI report for monitoring purpose.

In a yet another embodiment of the disclosure, when the two CSI reports are configured in a single CSI report configuration, the base station configures a single higher layer parameter for CSI report quantity to be reported. In this case, the UE considers the CSI report quantity indicated by the higher layer parameter reportQuantity for reporting of the two CSI reports for the predicted CSI and CSI report for monitoring.

In a yet another embodiment of the disclosure, when the two CSI reports are configured in a two linked CSI report configurations, the base station may configure a CSI report quantity in one of them. In particular, the base station may configure the higher layer parameter “reportQuantity” for CSI report configuration for predicted CSI and omit this higher layer parameter in the other CSI report configuration. In this case, the UE may consider the CSI report quantity configured in a CSI report configuration for predicted CSI while reporting CSI for monitoring purpose too.

In some cases the base station could be interested in adjusting the report quantity for the CSI report for monitoring purpose more dynamically. In such cases, the base station may indicate the desired report quantity via dynamic signaling, such as MAC-CE or DCI. Thus, in a yet another embodiment of the disclosure, when the two CSI reports are configured in a two linked CSI report configurations, the base station may indicate the desired report quantity for CSI report for monitoring purpose in dynamic signaling such MAC-CE or DCI. In this case, the UE may consider the CSI report quantity indicated by the dynamic signaling for the reporting CSI for monitoring purpose.

The CSI report configuration for predicted CSI could be configured with reporting quantity configured by higher layer parameter reportQuantity set to ‘cri-RI-PMI-CQI-LI’, ‘cri-RI-PMI-CQI’ or others. The CSI report configuration for monitoring purpose could be configured with reporting quantity with higher layer parameter reportQuantity set to ‘cri-RI-PMI-CQI-LI’, ‘cri-RI-PMI-CQI’, ‘cri-RSRP’, ‘cri-SINR’, ‘ssb-Index-RSRP’, ‘ssb-Index-SINR’, ‘cri-RI-CQI’.

When a base station compares the predicted CSI and a CSI report for monitoring purpose it may be beneficial for the UE to report the CSI report for monitoring purpose with same rank assumption and conditioned on one CSI-RS. Thus, for the CSI report for monitoring purpose the UE may omit reporting the CSI components CRI and RI. As a yet another aspect of this disclosure, when a UE is configured with report quantity for the CSI report for monitoring purpose with reportQuantity set to ‘cri-RI-PMI-CQI-LI’, ‘cri-RI-PMI-CQI’, ‘cri-RSRP’, ‘cri-SINR’, ‘ssb-Index-RSRP’, ‘ssb-Index-SINR’, ‘cri-RI-CQI’, the UE may calculate the CSI while assuming the reported CRI and RI for predicted CSI and omit CRI and RI in its CSI report for monitoring purpose.

In a yet another possible realization of the disclosure, the base station may configure the UE with CSI report for monitoring purpose with report quantity configured with higher layer parameter set to ‘PMI-CQI-LI’, ‘PMI-CQI’, ‘RSRP’, ‘SINR’, ‘RSRP’, ‘SINR’, ‘CQI’.

In some cases, the base station may only desire to compare the channel quality of the predicted CSI (PMI) in the actual predication (application window). In such cases, the bases station may configure the UE to report CQI by considering the PMI reported for the predicted CSI.

In a yet another aspect of the disclosure, the base station may configure the UE with report quantity ‘CQI’ ‘cqi-LI’ for monitoring purpose. Up on such configuration, the UE may

calculate the CQI for monitoring purpose conditioned on the reported PMI, RI and CRI for the predicted CSI

calculate the LI for monitoring purpose conditioned on the reported CQI for monitoring purpose and the reported PMI, RI and CRI for the predicted CSI

CSI processing units (CPU), Priority and Dropping Rules.

In the following, the CSI priority rules and dropping rules for predicted CSI and for monitoring purpose are elaborated below.

The CSI report for monitoring purpose may be reported based on measurements on monitoring measurement resources (MMRs). The prediction window for the predicted CSI is determined based on the CSI report configuration from the base station or based on UE's determination and indication on the CSI report for predicted CSI.

When the UE measures the CSI-RS resource for monitoring (MMR) to calculate the CSI for monitoring purpose, the CSI processing units (CPU) and the corresponding span of occupancy must be determined.

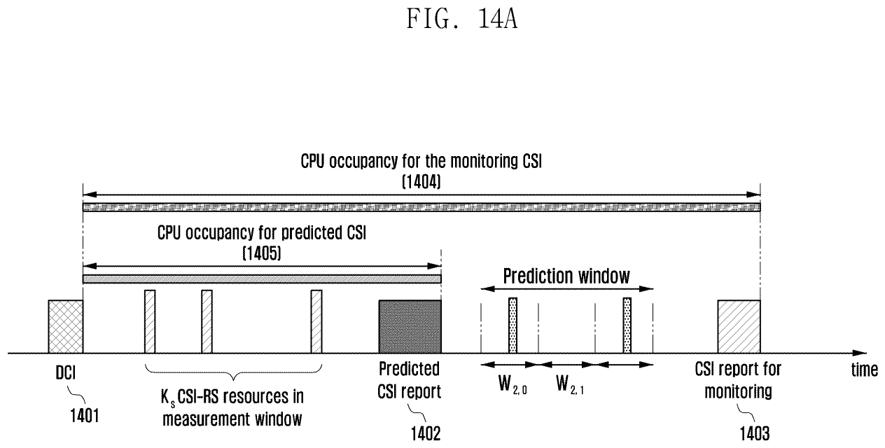

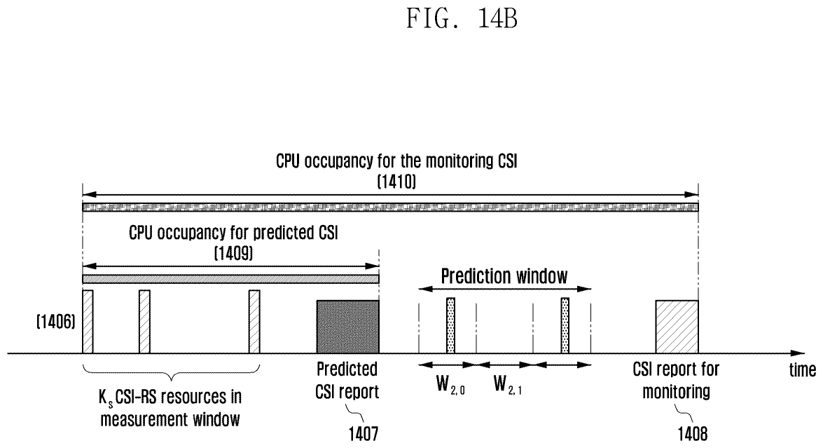

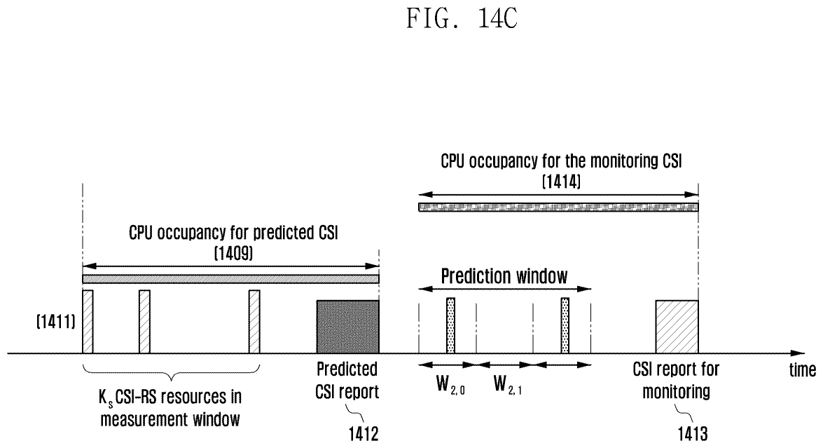

FIGS. 14A, 14B, and 14C illustrate embodiments for Aperiodic, Periodic and semi-persistent according to various embodiments of the disclosure.

Referring to FIG. 14, according to an embodiment of the disclosure, an aperiodic CSI report occupies CPU(s) 1404, 1405 from the first symbol after the physical downlink control channel (PDCCH) 1401 triggering the CSI report until the last symbol of the scheduled PUSCH(s) carrying the reports for predicted CSI 1402 and CSI for monitoring 1403, respectively.

According to a yet another embodiment of the disclosure, a periodic and semi-persistent CSI report (excluding an initial semi-persistent CSI report on PUSCH after the PDCCH triggering the report) occupies CPU(s) 1409, 1410 from the first symbol of the earliest one of each CSI-RS/CSI-interference measurement (IM)/SSB resource 1406 for channel or interference measurement, respective latest CSI-RS/CSI-IM/SSB occasion no later than the corresponding CSI reference resource, until the last symbol do the configured PUSCH/PUCCH carrying the reports for predicted CSI 1407 and CSI for monitoring 1408, respectively.

According to a yet another alternative embodiment of the current disclosure, a periodic and semi-persistent CSI report (excluding an initial semi-persistent CSI report on PUSCH after the PDCCH triggering the report) occupies CPU(s) 1409, 1414 from the first symbol of the earliest one of each CSI-RS/CSI-IM/SSB resource 1411 for channel or interference measurement for predicted CSI and for channel or interference measurement for monitoring CSI, respective latest CSI-RS/CSI-IM/SSB occasion no later than the corresponding CSI reference resource, until the last symbol do the configured PUSCH/PUCCH carrying the reports for predicted CSI 1412 and CSI for monitoring 1413, respectively.

In a yet another embodiment in accordance with the disclosure, an initial semi-persistent CSI report on PUSCH after the PDSCH trigger occupies CPU(s) from the first symbol after the PDCCH until the last symbol of scheduled PUSCH(s) carrying the report(s) for predicted CSI and CSI for monitoring, respectively.

In accordance of the disclosure, if an MMR is configured for monitoring CSI measurement and if the associated predicted CSI correspond to a prediction window which does not overlap with the slot wherein the MMR is received, the UE may ignore the MMR and may not include that measurement in its reporting.

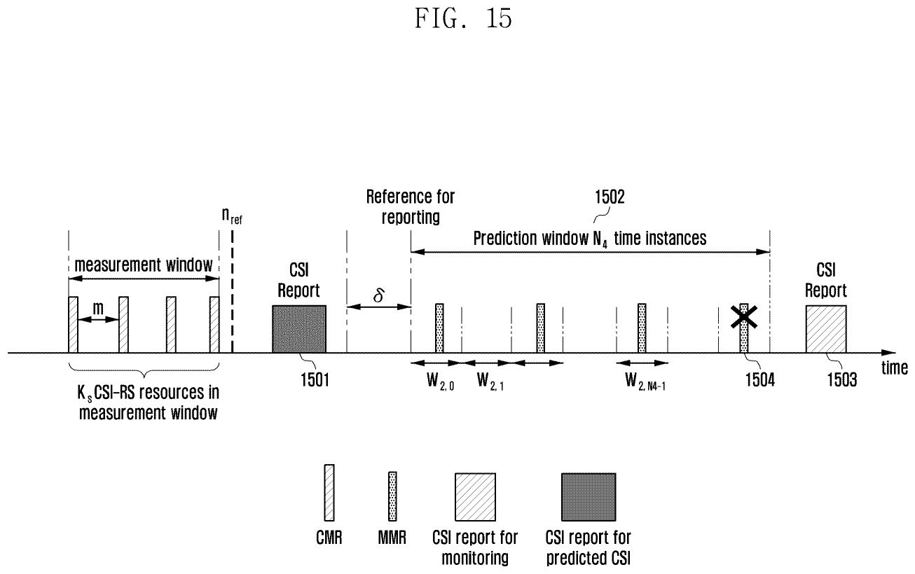

FIG. 15 depicts the case wherein the slot in which the latest MMR 1504 is not overlapped with the prediction window 1502 of the associated predicted CSI 1501 according to an embodiment of the disclosure. In this case, the UE is not expected to receive the MMR and thus CSI report for monitoring 1503 is not expected to contain CSI corresponding to the MMR 1504.

Moreover, when the CSI report corresponding to the predicted CSI is fully or partially dropped, the CSI report for monitoring purpose should also be fully or partially be dropped. This saves the radio resources and UE's transmission energy as the CSI report for monitoring purpose is of less use, if the predicted CSI is not reported.

Thus, in accordance to the disclosure, when the CSI report corresponding to the predicted CSI is fully or partially dropped, the CSI report for monitoring purpose should also be fully or partially be dropped.

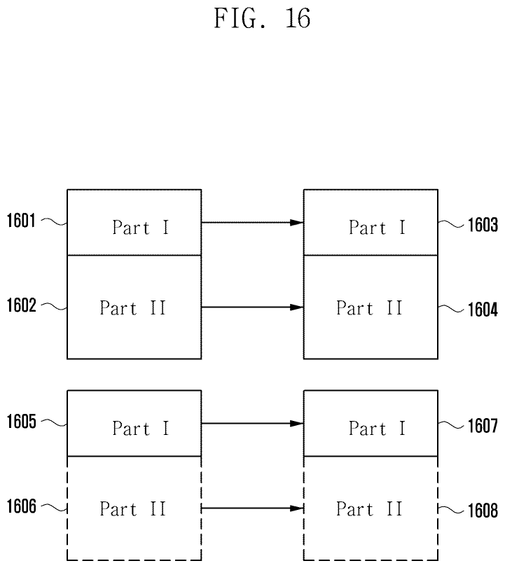

FIG. 16 illustrates Part I 1601, 1603, 1605, 1607 and Part II 1602, 1604, 1606, 1608 CSI for two CSIs are considered according to an embodiment of the disclosure. When the Part II CSI of the CSI report for predicted CSI is dropped, the corresponding Part II CSI for monitoring CSI is also dropped.

### Doppler-Domain Compression for Monitoring CSI Report

The CSI report for monitoring may correspond to multiple measurements (MMRs). The time-domain correlation among these measurements can then be exploited and the CSI can be compressed in the Doppler domain.

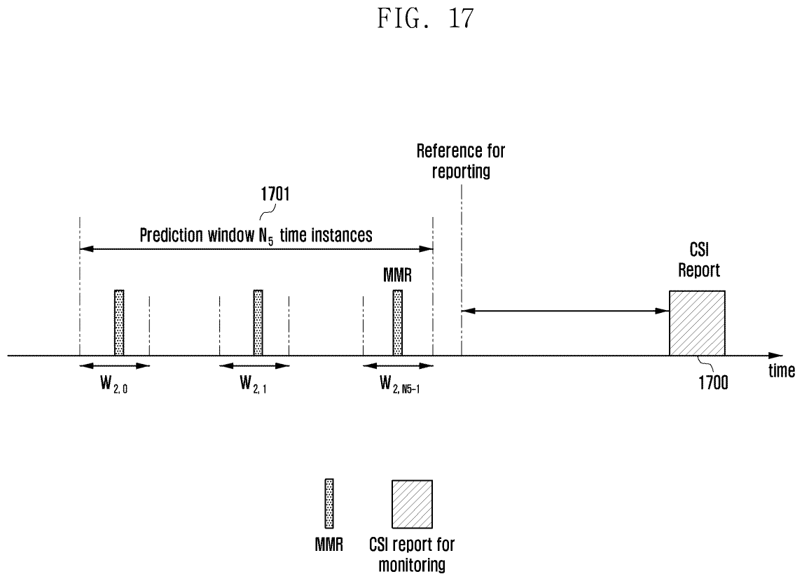

FIG. 17 illustrates Doppler-domain compression-based for CSI measurements from multiple CSI-RS resources for monitoring according to an embodiment of the disclosure.

Referring to FIG. 17, N₄ MMRs in the prediction window of the corresponding predicted CSI 1701 are measured and the CSI report 1700 for monitoring corresponding to these N₅ measurements are reported after Doppler-domain compression. In particular, N₅ precoding vectors may correspond to the N₄ MMRs. For example, the precoding vector for the n-th MMR can be expressed as Wn=W₁W_{2,n}W_{f}^{H} where W₁ and W_{f}^{H} represent the spatial and frequency-domain basis vectors, respectively, and W_{2,n} represents the combining coefficients. Then, the N₅ measurements can be compressed and thus expressed as W=W₁W_{2,n}(W_{f}└W_{d})^{H} wherein W_{d} represents the Doppler-domain basis vectors.

In accordance to an embodiment of the disclosure, the base station configures the UE for reporting of CSI for monitoring purpose corresponding to multiple measurements wherein the configuration information includes the number of measurement resources (N₅), the number of spatial (L), frequency (N₃) and Doppler-domain (M_{d}) basis vectors, the amplitude and phase quantization information, the maximum number of non-zero elements of the linear-combing matrices.

In accordance to a yet another embodiment of the disclosure, the base station configures the UE for reporting of CSI for monitoring purpose corresponding to multiple measurements wherein the same configuration information if partially or fully shared between the two linked CSI reports for the predicted CSI and CSI for monitoring. The information includes the number of measurement resources (N₅), the number of spatial (L), frequency (N₃) and Doppler-domain (Ma) basis vectors, the amplitude and phase quantization information, the maximum number of non-zero elements of the linear-combing matrices.

### Capability Report

Various models of UE may have different capabilities pertaining to the disclosed methods and systems above. For example, a UE may have limited capability on the number of channel measurements it can perform within a certain time duration. A UE may have limited capability in terms of memory/storage on the maximum duration it can buffer the measurements.

In accordance to one aspect of the disclosure, the UE reports its capability on the maximum number of CSI-RS resources for monitoring (MMRs), the maximum number of ports per resource or the total number of ports across measurement resources (MMRs). Upon reception of such capability report, the base station configures the UE with measurement and reporting configuration within the capability of the reported capability report in accordance to the disclosure.

In accordance to one aspect of the disclosure, the UE reports its capability on the maximum duration for measurement for CSI-RS resources for monitoring. The capability report may be reported in time units. One time unit is transmission slot. If the UE reports X slots as its capability report, the UE does not expect to be configured to measure CSI for monitoring purpose where in the first and the last measurement resources are with X consecutive slots.

In accordance to one aspect of the disclosure, the UE reports its capability on the maximum number of CSI reports for monitoring purpose that can be simultaneously computed. The capability report may be reported in terms of CSI processing units (CPU). The reported CPU could be shared to determine the number of simultaneously processed CSI for monitoring and other purposes.

### CSI Compression via Fronthaul

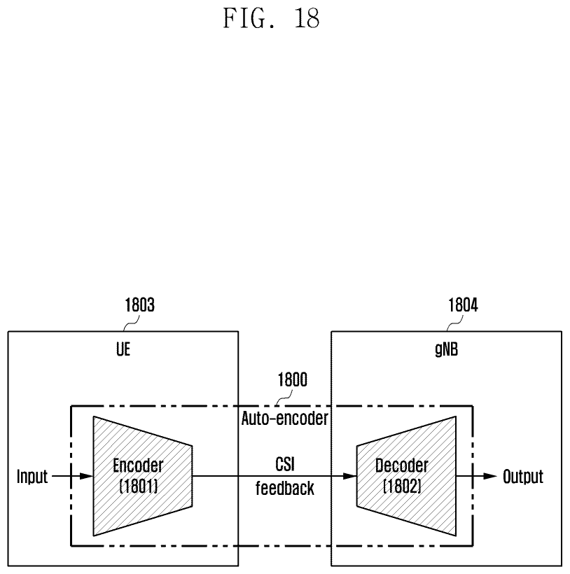

FIG. 18 illustrates an auto-encoder (AE) consisting of an encoder part at the UE and a decoder at the gNB according to an embodiment of the disclosure.

Recently, artificial intelligence (AI)-based CSI feedback has gained considerable attention. Referring to FIG. 18, an auto-encoder (AE) 1800 consisting of an encoder part 1801 at the UE 1803 generates the CSI feedback and a decoder 1802 at the gNB 1804 reconstructs the CSI feedback. The main aim of an AE-based CSI feedback is to find the best representation of a channel state information in terms of feedback overhead. In another words, AE compresses the CSI to reduce the CSI feedback overhead.

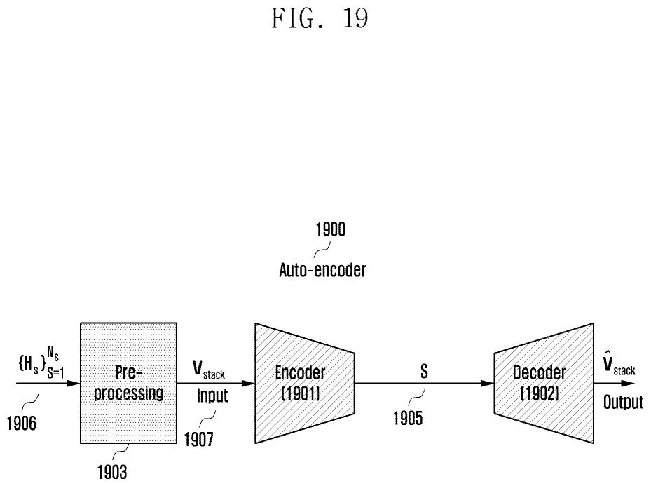

FIG. 19 illustrates formats for an input of auto-encoder according to an embodiment of the disclosure.

Referring to FIG. 19, the input for an autoencoder can take different formats. In an embodiment of the disclosure, the input can be the eigenvectors of the channel. The covariance matrix of an Nₜ×Nᵣ channel matrix H given as H^{H}H can be computed by the UE. Then, the dominant eigenvectors of the covariance matrix eig(H″H)=VΣΛ given as V=[v₁ . . . vᵣ] can be considered as an input for the autoencoder. An illustration of such embodiment is given in FIG. 19. A set of Nₛ channel matrices which belong to Nₛ subbands, i.e., {Hₛ}ₛ₌₁^{N}^{ₛ}, is input 1906 for a pre-processing unit in 1903. The preprocessing unit compute the Nₛ eigenvectors and stack them as a column of a matrix V_{stack} 1907. An encoder 1901 then generates a CSI feedback in terms of a bit stream s 1905. The decoder 1902 part of the autoencoder 1900, takes the CSI feedback and reconstructs the stacked eignvectors. Moreover, a gNB then may use the reconstructed stacked eigenvectors \hat{V}_{stack} as precoders.

As aforementioned, in 4G and 5G systems, the UE reports the precoding matrices via their indices as part of CSI report. However, if the ‘full channel matrices’, i.e., the H matrices, are available at the gNB, various advantages can be reaped. One advantage is better interference nulling for multi-user MIMO (MU-MIMO) use case. Additionally, with the availability of full channel matrices at the gNB, the gNB can predict the future channel or precoder with higher accuracy as compared to the prediction with only the precoding matrices are available at the gNB.

In this disclosure, a multitude of full channel matrices delivery mechanisms are presented. The full channel delivery mechanisms apply from UE to radio unit (RU) or from RU to the DU.

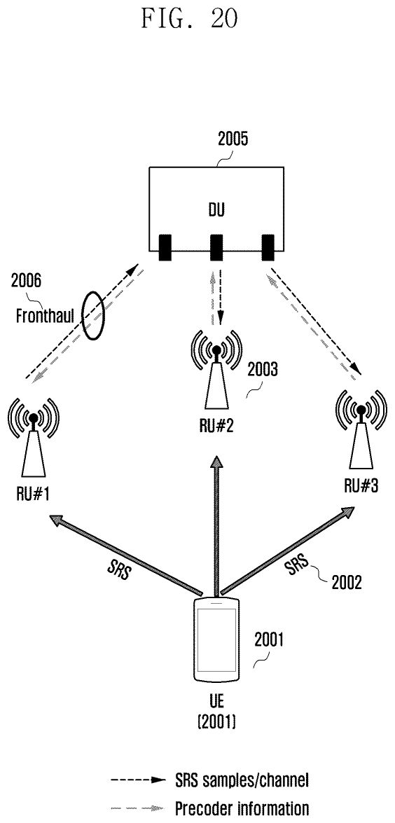

FIG. 20 illustrates channel measurement from SRS and channel delivery from RU to the DU according to an embodiment of the disclosure.

Referring to FIG. 20, in accordance to an embodiment of the disclosure, the RU 2003 based on the configuration received from the distributed unit 2005 measures SRS 2002 transmitted from the UE 2001. The RU 2003 applies an AI/ML based encoder to compress the channel and deliver the CSI via the fronthaul 2006.

In accordance to a yet another embodiment of the disclosure, the DU applies an AI/ML based encoder to decompress or reconstruct the CSI which is delivered via the fronthaul 2006.

In accordance to a yet another embodiment of the disclosure, the DU applies an AI/ML based encoder to decompress or reconstruct the CSI which is delivered via the fronthaul 2006.

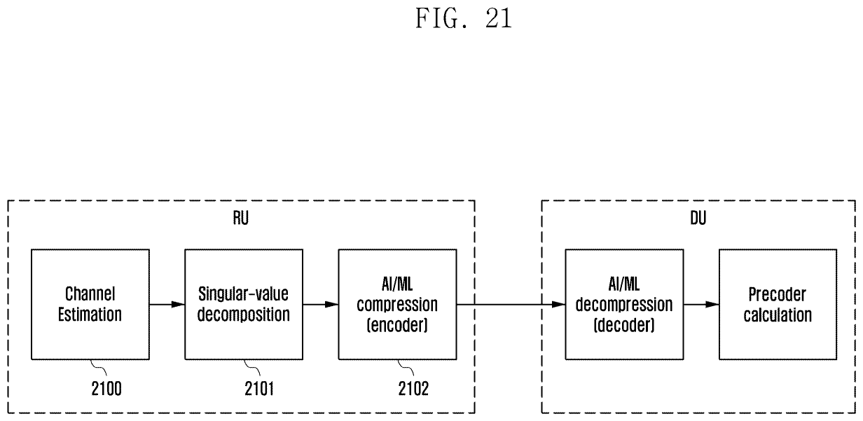

FIG. 21 illustrates procedures for RU preprocessing the SRS signal according to an embodiment of the disclosure.

Referring to FIG. 21, in a yet another embodiment of this disclosure, the RU preprocess the SRS signal by performing channel estimation 2100, singular value decomposition (SVD) 2101 and compress the left and right-hand side eignvectors as an input to the AI/ML encoder 2102.

For the ease of the description of the disclosure, let H be an Nr×Nt channel matrix corresponding to a PMI reporting subband. Such channel matrix can be decomposed as H=UΣV^{H} where the svd(HH^{H})=U^{H}Σ²U and svd(H^{H}H)=VΣ²V^{H}. Then, the UE-side matrix, i.e, U=[u₁, u₂, . . . ] and the gNB-side matrix, i.e., V=[v₁, v₂, . . . ] can be used to reconstruct the full channel matrices. In particular, for transmission layer l, the scaled version of the channel matrix can be reconstructed as Hl=ulvₗ^{H} where H=Σlulvₗ^{H} and λl is the l-th eigenvalue.

In a yet another aspect of the current disclosure, the RU upon reception of configuration message from the DU about rank information, it compresses Hl=ulvₗ^{H} for 1=1, 2, . . . , rank after channel estimation and SVD operations. In this case the input for AI/ML decoder will be the set of left and right eignvectors {ul, vₗ^{H}} for a given rank.

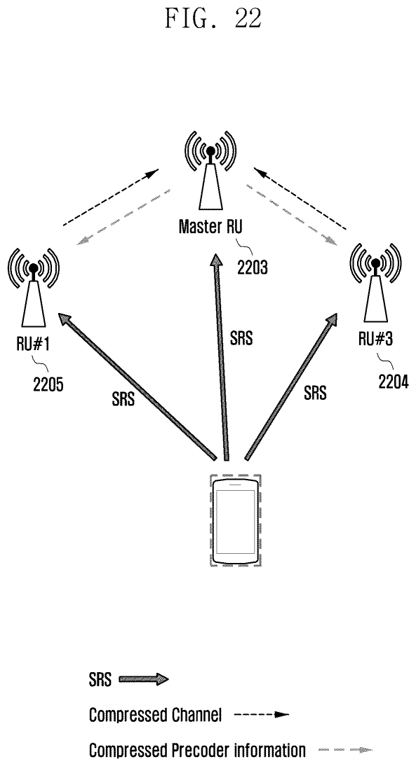

FIG. 22 illustrates channel measurement from SRS by RUs including master RU according to an embodiment of the disclosure.

Referring to FIG. 22, in a yet another aspect of the current disclosure, a particular RU is assigned as master RU (by the DU) or proactively by self-assignment or based on a predefined rule and coordinate the CSI calculation. In this case the neighboring RUs 2204 and 2205 send their channel measurement via AI/ML compression to the master RU 2203. The master RU would calculate the precoding matrix to the neighboring RUs and apply AI/ML compression on the precoders.

Distributed architecture has become the baseline architecture for modern radio access networks (RAN) wherein the RAN functionality is split between fronthaul-connected distributed unit (DU) and spatially-scattered radio units (RUs). The full potential of distributed MIMO, i.e., a UE served by multiple RUs, can be exploited with joint precoding and scheduling computations across the multiple RUs. However, this may require delivery of high resolution channel state information (CSI) from RUs to the DU for centralized processing. The state-of-the-art architectural options, however, fall short of achieving this to the full extent due to fronthaul capacity limitations resulting in quantization loss and delay in the CSI delivery. The disclosure introduces AI/ML-based CSI compression across the FH to alleviate this limitation. Preliminary results show that the proposed compression may reduce the required FH overhead dramatically, e.g., 1% FH overhead as compared to quantization benchmark of the related art, while the channel information can be delivered with [near-lossless] accuracy, e.g., −15 dB quantization loss. Finally, the disclosure propose a fully distributed architectural enhancement that may heavily reduce the involvement of DU to further improve performance.

Distributed MIMO also known as multi-transmission reception points (mTRP) scheme is considered as one of the important features supported by the 5G NR system. The spatially-scattered TRPs provide large-scale channel diversity which in turn enables higher system and user-perceived throughput, better interference management and seamless handover. For mTRP schemes, the channel state information (CSI) between the UE and the multiple TRPs is obtained through uplink or downlink measurements. Uplink measurement utilizes the sounding reference signal (SRS) transmitted by the UE towards the TRPs. In the legacy distributed RAN architecture, the channel information from SRS samples measured at the TRPs, or RUs using the O-RAN alliance lexicon, are conveyed to the DU for joint processing.

Without loss of generality, consider a MIMO channel between an RU and a UE equipped with N and M transceiver antenna ports, respectively. As the extension to multiple RUs is trivial, in the below, the disclosure focus on a single RU.

Let H_{S} denote an N×M MIMO channel for the s-th frequency unit. The received SRS samples for the same frequency unit, denoted by Y_{SRS,s} in a matrix form, is given as

$${Y}_{SRS , s} = {H}_{s} {s}_{SRS , s} + {n}_{s} \qquad Equation 1$$

where s_{SRS,s} is an M×M diagonal matrix with the m-th diagonal element corresponds to the SRS coefficient transmitted by m-th antenna port of the UE and nₛ denotes a noise vector. In RU-DU interface of the related art, referred as ‘baseline1’ hereinafter, Y_{SRS,s} is quantized to 32 bits per element, i.e., 16 bits per I/Q dimension. Thus, for a system with Nₛ frequency units, 32×Nₛ×N×M bits are required to convey a single SRS measurement to the DU. This implies for 10 MHz, i.e., Nₛ=52RBs considering RBs as frequency units, delivering for example, 32×4 matrices, Y_{SRS,s}, requires 212,882 bits.

Note that in some cases, the RU is capable of channel estimation. In this case, the estimated channel corresponding to Hₛ is quantized and transmitted to the DU. However, in the aforementioned quantization scheme of the related art, the delivery overhead stays the same as Hₛ and Y_{SRS,s} have the same dimension.

Once the channel estimates corresponding to Hₛ from one or more RUs is available at the DU, the DU determines the co-scheduled users and considers their channel to calculate the corresponding precoding vectors. Consider the N×1 precoding vector for a certain MIMO layer and s-th frequency unit denoted by wₛ. In the canonical form, hereafter referred as ‘baseline2’, 32 bits are required to quantize each of the complex coefficient of wₛws, i.e., a total overhead of 32×Nₛ×N bits are used for the Ns frequency units. The 5G O-RAN introduced the beamspace compression (BSC) algorithm, hereafter refereed as ‘baseline3’, which represents the precoding vectors in the beam-domain, after DFT projection. Then, the coefficients corresponding to the significant beams are delivered to RU.

In the following, the disclosure how the AI/ML-based compression can be utilized to compress the SRS channel matrices and the precoding vectors. To exploit frequency-domain correlation in the compression process, the concatenated inputs across the frequency units are considered which are denoted by H=[H₁ . . . . H_{Ns}] and W=[w₁ . . . W_{Ns}]. In particular, two separate autoencoders are considered for SRS channel compression from RU to DU and precoding vectors compression from DU to RU, respectively.

The objective for the proposed SRS channel compression is to minimize the quantization error of the SRS samples or channel while representing them with a codeword c of length L. Thus, the compression ratio as compared to baseline1 is given as

$${γ}_{SRS} = \frac{L}{32 \times {N}_{s} \times N \times M} .$$

To achieve this, the encoding and decoding models with parameter θ_{enc} and θdec, respectively, are trained using the following equation:

$${θ}_{enc}^{*} , {θ}_{dec}^{*} = arg {min}_{{θ}_{enc} , {θ}_{dec}} loss ( H , \hat{H} ) \\ s . t \hat{H} = {f}_{dec} ( c , {θ}_{dec} ) , c = {f}_{enc} ( H , {θ}_{enc} ) \qquad Equation 2$$

Conversely, the encoding and decoding models for precoding vectors compression with parameter θ_{enc}′ and θ_{dec}′ are trained using the following equation:

$${θ}_{enc}^{′ *} , {θ}_{dec}^{′ *} = arg {min}_{{θ}_{enc}^{′} , {θ}_{dec}^{′}} loss ( W , \hat{W} ) \\ s . t \hat{W} = {f}_{dec} ( c , {θ}_{dec}^{′} ) , c = {f}_{enc} ( W , {θ}_{enc}^{′} ) \qquad Equation 3$$

Input preprocessing, as a form of feature extraction, plays a crucial role in the reduction of the required AI/ML model complexity and shortening the convergence time for training. More particularly, in our SRS channel and precoding vectors compression, extracting the salient features of the H and W, simplifies the compression issue to the AI/ML model effectively. For this, the disclosure has considered the singular value decomposition (SVD) as Hₛ=Uₛ ∧ₛ Vₛ^{H}, where Uₛ and Vₛ^{H} are an M×r UE-side and an N×r RU-side eigenvector matrices for a given rank, r, respectively. This preprocessing requires the RU to be capable of performing SVD operations. However, such capability has increasingly become common. Then, upon request by the DU, the RU may compress and share the few dominant eigenvectors, e.g., H_{s,l}=u_{s,l}v_{s,l}^{H}, where U_{s,l} and V_{s,l}^{H} for layers, l=1, . . . , r. Note here that Hₛ=Σ_{s,l}H_{s,l}.

In our work, bi-LSTM-based autoencoders are considered for both SRS channel and precoding vectors compression. The encoder consisting of the three bi-LSTM layers and Tanh activation. At the input layer, the eigenvectors as described in the above preprocessing are stacked to form Ns×2 (N+M) input, i.e., Ns concatenated imaginary and real parts of RU-side and UE-side eigenvectors of a frequency unit.

As indicator of the expected gain from the proposed scheme, results are presented in Table 5 based on the evaluation assumption in Table 4. As a measure of accuracy, the quantization error which is calculated for input x and its reconstructed output \hat{x} is defined as

$${Q}_{loss} ( x , \hat{x} ) = E \{ 1 - \frac{\vert {x}^{H} \hat{x} \vert}{\vert x \vert \vert \hat{x} \vert} \}$$

where E{·} is expectation operator. For baseline1, perfect accuracy is assumed.

TABLE 4
Evaluation parameters

| Parameter | Value | Parameter | Value |
|---|---|---|---|
| N | 32 | M | 4 |
| Ns | 13 | Channel | Uma |
| Indoor UEs ratio | 0.8 | Indoor UE speed | 3 Kmhr |
| Frequency | 2 GHz | Outdoor UE speed | 30 Kmhr |

TABLE 5
SRS channel compression

| Overhead bits: | Overhead bits: | Compression ratio | Qₗₒₛₛ |
|---|---|---|---|
| Baseline1 | Proposed | (% age) | (dB) |
| 53248 | 55 | 0.10 | −9.98 |
| 53248 | 157 | 0.29 | −12.03 |
| 53248 | 272 | 0.51 | −12.89 |
| 53248 | 564 | 1.06 | −15.42 |

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving, from a base station via higher layer signaling, one or more configurations;
identifying a first CSI report for prediction and a second CSI report for monitoring based on the one or more configurations; and
transmitting, to the base station, the first CSI report for prediction and the second CSI report for monitoring.

2. The method of claim 1,
wherein the one or more configurations includes a first configuration associated with the first CSI report for prediction and a second configuration associated with CSI report for monitoring,
wherein the first configuration and the second configuration are linked, and
wherein the first configuration includes a first codebook configuration for the first CSI report for prediction and the second configuration includes a second codebook configuration for the second CSI report for monitoring.

3. The method of claim 1,
wherein the one or more configurations includes a single configuration, and
wherein the single configuration includes a first a first codebook configuration for the first CSI report for prediction and a second codebook configuration for the second CSI report for monitoring, or
wherein the single configuration includes a single codebook configuration for the first CSI report for prediction and the second CSI report for monitoring.

4. The method of claim 2,
wherein a first parameter indicating a report quantity of the first CSI report for prediction is included in the first configuration and a second parameter indicating a report quantity of the second CSI report for monitoring is included in the second configuration, or
wherein the first parameter indicating the report quantity of the first CSI report for prediction is included in the first configuration, the second parameter indicating the report quantity of the first CSI report for monitoring is omitted in the second configuration, and the second parameter is same as the first parameter, or
wherein the first parameter indicating the report quantity of the first CSI report for prediction is included in the first configuration, and the second parameter indicating the report quantity of the first CSI report for monitoring is indicated via dynamic signaling.

5. The method of claim 3,
wherein the single configuration includes a first parameter indicating a report quantity of the first CSI report for prediction and a second parameter indicating a report quantity of the second CSI report for monitoring, or
wherein the single configuration includes a single parameter indicating a report quantity of the first CSI report for prediction and the second CSI report for monitoring.

6. A method performed by a base station in a communication system, the method comprising:
transmitting, to a user equipment (UE) via higher layer signaling, one or more configurations associated with a first CSI report for prediction and a second CSI report for monitoring; and
receiving, from the UE, the first CSI report for prediction and the second CSI report for monitoring.

7. The method of claim 6,
wherein the one or more configurations includes a first configuration associated with the first CSI report for prediction and a second configuration associated with CSI report for monitoring,
wherein the first configuration and the second configuration are linked, and
wherein the first configuration includes a first codebook configuration for the first CSI report for prediction and the second configuration includes a second codebook configuration for the second CSI report for monitoring.

8. The method of claim 6,
wherein the one or more configurations includes a single configuration, and
wherein the single configuration includes a first a first codebook configuration for the first CSI report for prediction and a second codebook configuration for the second CSI report for monitoring, or
wherein the single configuration includes a single codebook configuration for the first CSI report for prediction and the second CSI report for monitoring.

9. The method of claim 7,
wherein a first parameter indicating a report quantity of the first CSI report for prediction is included in the first configuration and a second parameter indicating a report quantity of the second CSI report for monitoring is included in the second configuration, or
wherein the first parameter indicating the report quantity of the first CSI report for prediction is included in the first configuration, the second parameter indicating the report quantity of the first CSI report for monitoring is omitted in the second configuration, and the second parameter is same as the first parameter, or
wherein the first parameter indicating the report quantity of the first CSI report for prediction is included in the first configuration, and the second parameter indicating the report quantity of the first CSI report for monitoring is indicated via dynamic signaling.

10. The method of claim 8,
wherein the single configuration includes a first parameter indicating a report quantity of the first CSI report for prediction and a second parameter indicating a report quantity of the second CSI report for monitoring, or
wherein the single configuration includes a single parameter indicating a report quantity of the first CSI report for prediction and the second CSI report for monitoring.

11. A user equipment (UE) in a communication system, the UE comprising:
a transceiver; and
at least one processor configured to:
receive, from a base station via higher layer signaling, one or more configurations,
identify a first CSI report for prediction and a second CSI report for monitoring based on the one or more configurations, and
transmit, to the base station, the first CSI report for prediction and the second CSI report for monitoring.

12. The UE of claim 11,
wherein the one or more configurations includes a first configuration associated with the first CSI report for prediction and a second configuration associated with CSI report for monitoring,
wherein the first configuration and the second configuration are linked, and
wherein the first configuration includes a first codebook configuration for the first CSI report for prediction and the second configuration includes a second codebook configuration for the second CSI report for monitoring.

13. The UE of claim 11,
wherein the one or more configurations includes a single configuration, and
wherein the single configuration includes a first a first codebook configuration for the first CSI report for prediction and a second codebook configuration for the second CSI report for monitoring, or
wherein the single configuration includes a single codebook configuration for the first CSI report for prediction and the second CSI report for monitoring.

14. The UE of claim 12,
wherein a first parameter indicating a report quantity of the first CSI report for prediction is included in the first configuration and a second parameter indicating a report quantity of the second CSI report for monitoring is included in the second configuration, or
wherein the first parameter indicating the report quantity of the first CSI report for prediction is included in the first configuration, the second parameter indicating the report quantity of the first CSI report for monitoring is omitted in the second configuration, and the second parameter is same as the first parameter, or
wherein the first parameter indicating the report quantity of the first CSI report for prediction is included in the first configuration, and the second parameter indicating the report quantity of the first CSI report for monitoring is indicated via dynamic signaling.

15. The UE of claim 13,
wherein the single configuration includes a first parameter indicating a report quantity of the first CSI report for prediction and a second parameter indicating a report quantity of the second CSI report for monitoring, or
wherein the single configuration includes a single parameter indicating a report quantity of the first CSI report for prediction and the second CSI report for monitoring.

16. A base station in a communication system, the base station comprising:
a transceiver; and
at least one processor configured to:
transmit, to a user equipment (UE) via higher layer signaling, one or more configurations associated with a first CSI report for prediction and a second CSI report for monitoring, and
receive, from the UE, the first CSI report for prediction and the second CSI report for monitoring.

17. The base station of claim 16,
wherein the one or more configurations includes a first configuration associated with the first CSI report for prediction and a second configuration associated with CSI report for monitoring,
wherein the first configuration and the second configuration are linked, and
wherein the first configuration includes a first codebook configuration for the first CSI report for prediction and the second configuration includes a second codebook configuration for the second CSI report for monitoring.

18. The base station of claim 16,
wherein the one or more configurations includes a single configuration, and
wherein the single configuration includes a first a first codebook configuration for the first CSI report for prediction and a second codebook configuration for the second CSI report for monitoring, or
wherein the single configuration includes a single codebook configuration for the first CSI report for prediction and the second CSI report for monitoring.

19. The base station of claim 17,
wherein a first parameter indicating a report quantity of the first CSI report for prediction is included in the first configuration and a second parameter indicating a report quantity of the second CSI report for monitoring is included in the second configuration, or
wherein the first parameter indicating the report quantity of the first CSI report for prediction is included in the first configuration, the second parameter indicating the report quantity of the first CSI report for monitoring is omitted in the second configuration, and the second parameter is same as the first parameter, or
wherein the first parameter indicating the report quantity of the first CSI report for prediction is included in the first configuration, and the second parameter indicating the report quantity of the first CSI report for monitoring is indicated via dynamic signaling.

20. The base station of claim 18,
wherein the single configuration includes a first parameter indicating a report quantity of the first CSI report for prediction and a second parameter indicating a report quantity of the second CSI report for monitoring, or
wherein the single configuration includes a single parameter indicating a report quantity of the first CSI report for prediction and the second CSI report for monitoring.
